(19) United States
(12) Patent Application Publication
(10) Pub. No.: US 2004/0106405 A1
(43) Pub. Date: Jun. 3, 2004

(54) Method of implementing an admission control algorithm in a telecommunications system

(75) Inventors: Anne Gabriel, Paris (FR); Pascal Agin, Sucy En Brie (FR)

Correspondence Address: SUGHRUE MION, PLLC, Suite 800, 2100 Pennsylvania Avenue, N.W., Washington, DC, 20037-3213, US

(73) Assignee: EVOLIUM S.A.S.

(21) Appl. No.: 10/615,850

(22) Filed: Jul. 10, 2003

(30) Foreign Application Priority Data
Jul. 11, 2002 (FR) 02 08 727

(51) Int. Cl. H04Q 7/20

(52) U.S. Cl. 455/435.1; 455/452.2; 455/422.1

(57) ABSTRACT

The present invention provides a method of implementing an admission control algorithm in a telecommunications system, in which method at least one parameter of said algorithm is adapted dynamically as a function of a traffic model representative of the traffic present.

The present invention relates generally to telecommunications systems and more particularly to managing transmission resources and quality of service in telecommunications systems.

The present invention is applicable in particular to mobile radio systems, especially third generation mobile radio systems such as the Universal Mobile Telecommunications System (UMTS).

As a general rule, mobile radio systems are covered by standards and the standards published by the corresponding standardization organizations can be consulted for more information.

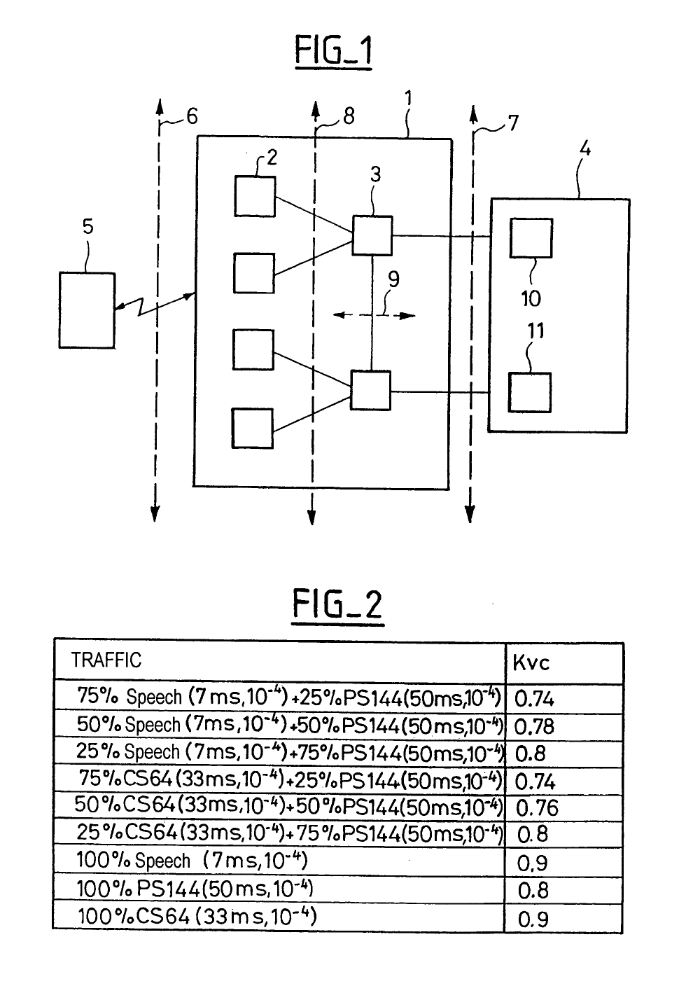

FIG. 1 outlines the general architecture of mobile radio systems, which essentially comprises:

a radio access network (RAN) 1, and

a core network (CN) 4.

The radio access network is made up of base stations 2 and base station controllers 3. It communicates with mobile terminals 5 via a radio interface 6 and with the core network 4 via an interface 7. Within the radio access network, the base stations communicate with the base station controllers via an interface 8.

In the UMTS, the radio access network is called the UMTS Terrestrial Radio Access Network (UTRAN), a base station is called a Node B, a base station controller is called a radio network controller (RNC), and a mobile terminal is called a user equipment (UE). The radio interface 6 is called the Uu interface, the interface 7 is called the Iu interface, the interface 8 is called the Iub interface, and the interface 9 between radio network controllers is called the Iur interface. The core network essentially contains network entities or nodes such as mobile switching centers (MSC) 10 and serving general packet radio service (GPRS) serving nodes (SGSN). The interface between an RNC and an MSC is known as the Iu-CS interface, where “CS” stands for “circuit-switched”, and the interface between an RNC and an SGSN is known as the Iu-PS interface, where “PS” stands for “packet-switched”.

A transport technique widely used in the UTRAN is the asynchronous transfer mode (ATM) technique based on asynchronous time division multiplexing of small packets of fixed size known as cells. As a general rule, the ATM technique is covered by standards, and the standards published by the corresponding standardization organizations can be consulted for more information. Suffice to say that an ATM network can be modeled by means of an ATM layer and an ATM adaptation layer (AAL) between the ATM layer and users. The ATM layer is connection-oriented and relies on transmission of cells over a logical connection between a source and a destination. The logical connection is also known as a virtual channel (VC).

A dedicated ATM adaptation layer (AAL2) is used to apply the ATM technique to transport within the UTRAN. When a UE is communicating with the UTRAN, a corresponding logical connection (AAL2 connection) can be set up at one or more of the UTRAN interfaces concerned, usually the Iub, Iu-CS, and Iur interfaces. These AAL2 connections are generally low bit rate connections, because of the low bit rate of transmission at the radio interface, and in this case a plurality of AAL2 connections is advantageously multiplexed within the same ATM connection or ATM virtual circuit.

The transmission resources required for different AAL2 connections liable to be multiplexed onto the same ATM virtual circuit can be different, because the AAL2 connections can correspond to different types of traffic or service, which may have different quality of service (QoS) requirements. Remember that in the UMTS there are four classes of traffic: conversational, streaming, interactive, and background. There are also QoS parameters for each traffic class, such as the maximum acceptable transmission time-delay, the probability that the transmission time-delay will be greater than the maximum acceptable transmission time-delay, the acceptable error rate, etc. In the example more specifically considered here of transport within the UTRAN, the target QoS, i.e. the QoS required for a given type of traffic or service, is represented by a maximum transmission time-delay and a probability that the transmission time-delay will be greater than the maximum time-delay. For example, for a traffic type corresponding to speech, the target QoS can be represented by a maximum transmission time-delay of 7 milliseconds (ms) and a probability of 10⁻⁴ that the transmission time-delay will be greater than 7 ms. The maximum transmission time-delay required can be different for different types of traffic or service. For example, the maximum transmission time-delay required for a telephone service is less than the maximum transmission time-delay required for a videophone service, which is itself less than the maximum transmission time-delay required for a web browser.

A connection admission control (CAC) algorithm is generally used to decide if the transmission resources are sufficient to accept a new AAL2 connection request at each UTRAN interface concerned, whilst guaranteeing that the required QoS is complied with.

The CAC algorithm is generally based on the equivalent bandwidth (EB) concept. According to this concept, each AAL2 connection is associated with an equivalent bandwidth representing the amount of the bandwidth of an ATM virtual circuit that is estimated to be necessary to achieve the target QoS for the corresponding type of traffic or service. The CAC algorithm then only verifies that the sum of the equivalent bandwidths for the AAL2 connections already set up is less than the equivalent bandwidth of the ATM virtual circuit onto which they are multiplexed. The use of a margin corresponding to a maximum acceptable load for the ATM virtual circuit is commonly accepted. The margin essentially prevents overloads in which the ATM virtual circuit is overloaded and the transmission time-delays are then out of control.

In other words, the CAC algorithm consists in verifying if the sum of the equivalent bandwidths of the AAL2 connections already set up on the ATM virtual circuit satisfies the following condition:

ΣEB(i)≦K_{VC}×EB_{VC}

in which:

EB(i) is the equivalent bandwidth required for an AAL2 connection set up on the ATM virtual circuit for the service “i” and for a given target QoS, represented in particular by given maximum transmission time-delay and a given probability that the transmission time-delay will be greater than that maximum transmission time-delay,

K_{VC} is the margin corresponding to the maximum acceptable load for the ATM virtual circuit (typically having a value from 0.7 to 0.9), and

EB_{VC} is the equivalent bandwidth of the ATM virtual circuit onto which the AAL2 connections are multiplexed. For example, in the case of a constant bit rate (CBR) ATM class of service, the equivalent bandwidth of the ATM virtual circuit is equal to the maximum cell bit rate, which is also known as the peak cell rate (PCR).

The invention is explained using the “traffic model” concept. In the example of application of the invention to transport within the UTRAN, a traffic model can include QoS parameters (such as the maximum transmission time-delay and the probability that the transmission time-delay will be greater than the maximum transmission time-delay) for each type of traffic that can be multiplexed within a virtual circuit and, in the case of different types of traffic, relative proportions for the various traffic types.

For a given traffic model the margin, or the maximum acceptable load for the ATM virtual circuit, is generally determined by simulation, the virtual circuit load increasing until the maximum time-delay constraints for the AAL2 connections are no longer complied with, which indicates that the maximum load has been reached.

As the applicant has observed, one problem is that the rule previously outlined, on which the CAC algorithm is based, remains the same, and in particular the margin remains the same, and this applies to all possible traffic models.

Now, in order to comply with the target QoS for the various AAL2 connections multiplexed onto the virtual circuit, the maximum acceptable load for the ATM virtual circuit can be different for different traffic models, and also depends on the target QoS associated with each type of traffic or service.

This means that if a value of K_{VC} is chosen that must remain valid for all possible traffic models, it is reasonable to choose the value for the traffic model with the most severe constraints. In other words, the traffic model that requires the smallest maximum load for the virtual circuit is chosen. However, this also signifies that for a traffic model different from the traffic model for which the value of K_{VC} has been optimized in this way, the CAC algorithm will refuse some connections which could in reality have been accepted and for which the target QoS would have been satisfactory. In other words, this rules out optimum use of the bandwidth of the virtual circuit for all possible traffic models; to put this another way, the use of transmission resources within the UTRAN is not optimized.

In other words, in the prior art outlined above, one traffic model is selected in a fixed manner, and the maximum acceptable load for the virtual circuit is then determined by simulation, measurement or calculation. A reasonable solution is then to select the traffic model with the lowest value of the maximum acceptable load for the virtual circuit.

That kind of solution is not satisfactory, for the reasons explained above, and in particular because there may be a large number of traffic models, in other words there may be a large number of combinations of traffic types and their relative proportions, for example (the following list is not exhaustive):

100% AMR: all the load is adaptive multirate (AMR) traffic,

100% CS64: all the load is CS64 traffic (i.e. circuit-switched (CS) traffic at 64 kilobits per second (kbit/s)),

100% PS64: all the load is PS64 traffic (i.e. packet-switched (PS) traffic at 64 kbit/s),

100% PS128: all the load is PS128 traffic, (i.e. packet-switched (PS) mode traffic at 128 kbit/s),

100% PS144: all the load is PS144 traffic, (i.e. PS mode traffic at 144 kbit/s),

100% PS384: all the load is PS384 traffic, (i.e. PS mode traffic at 384 kbit/s),

50% AMR+50% PS64: 50% of the load is AMR traffic and 50% of the load is PS64 traffic,

25% AMR+75% PS128: 25% of the load is AMR traffic and 75% of the load is PS128 traffic,

etc.

Another reason why that prior art solution is not satisfactory is that the maximum acceptable load for the virtual circuit also depends on the target QoS associated with each type of traffic or service. For example, even in the case of only one type of traffic or service, the maximum acceptable load for the virtual circuit will differ according to the target QoS associated with that type of traffic or service. For example, the target QoS can be represented by a pair consisting of the maximum transmission time-delay and the probability that the transmission time-delay will be greater than the maximum transmission time-delay, in which case, depending on the type of traffic or service, the target QoS can correspond, for example, to the following pairs: (7 ms, 10⁻⁴), (7 ms, 10⁻⁵), (10 ms, 10⁻⁴), etc.

The infinite number of traffic models available makes it impossible to be sure that the traffic model for which the maximum load of the virtual circuit has been optimized will be the only traffic model used in the network.

An object of the present invention is to prevent some or all of the drawbacks previously mentioned. More generally, an object of the present invention is to optimize the use of transmission resources in mobile radio systems whilst complying with QoS constraints.

Although the above description makes particular reference, by way of example, to using CAC algorithms for AAL2 connection admission control on an ATM virtual circuit, in particular for the application to transport within the UTRAN, the present invention is not limited to this kind of application and can of course be used in any situation in which an admission control algorithm can be used to prevent congestion caused by traffic exceeding what the system can support. Thus admission control algorithms can be used not only for the multiplexing of AAL2 connections in an ATM virtual circuit, but also in any node of a packet-switched mode network, or at the radio interface of a code division multiple access (CDMA) system, etc. In packet-switched mode transmission resources are shared at any time by different users, whereas in circuit-switched mode resources are allocated to different users in a fixed manner. For example, in the UMTS, admission control can equally well be effected in a core network element, in packet-switched mode, to decide if the transmission resources in that network element are sufficient to accept a new call. Remember also that in CDMA systems capacity limitations at the radio interface are different from what they are in systems using other multiple access techniques, such as the time division multiple access (TDMA) technique. The TDMA technique is used in second generation systems such as the Global System for Mobile communications (GSM). The CDMA technique is used in third generation systems such as the UMTS. In CDMA systems, all users share the same frequency resource at any time. The capacity of these systems is therefore limited by interference and for this reason such systems are known as soft limited systems. For example, in the UMTS, admission control can also be effected to decide if the radio resources in a Node B are sufficient to accept a new call.

The invention provides a method of implementing an admission control algorithm in a telecommunications system, in which method at least one parameter of said algorithm is adapted dynamically as a function of a traffic model representative of the traffic present.

According to another feature, said traffic model includes one or more parameters representative of the type(s) of traffic present.

According to another feature, parameters representative of a type of traffic include parameters representative of quality of service (QoS) requirements for that traffic type.

According to another feature, parameters representative of quality of service requirements include a maximum transmission time-delay and a probability that the transmission time-delay will be greater than that maximum transmission time-delay.

According to another feature, parameters representative of the type of traffic include parameters representative of transmission resource requirements for said traffic type and for a given quality of service (QoS).

According to another feature, parameters representative of transmission resource requirements for a given quality of service (QoS) include a connection activity factor.

According to another feature, if different traffic types are present, said traffic model includes relative proportions for said different traffic types.

According to another feature, said at least one parameter corresponds to a margin corresponding to a maximum acceptable load.

According to another feature, said at least one parameter corresponds to an equivalent bandwidth.

According to another feature, the value of said at least one parameter is chosen from different reference values optimized for different reference traffic models.

According to another feature, for a traffic model that does not correspond to a reference traffic model, a reference traffic model is determined that constitutes the best approximation thereof.

According to another feature, for a traffic model that does not correspond to a reference traffic model, a reference traffic model is determined that constitutes the best approximation thereof and has the severest constraints.

According to another feature, the method includes a first step during which reference traffic models are determined and corresponding reference values for said at least one parameter are determined.

According to another feature, said reference values are determined by simulation or measurement.

According to another feature, said reference values are determined by calculation.

According to another feature, the method includes a second step during which reference traffic models and corresponding reference values are stored in a memory.

According to another feature, the method includes a third step during which a traffic model representative of the traffic present is estimated.

According to another feature, said estimation includes an estimation of the traffic types present and, if different traffic types are present, relative proportions for said different traffic types.

According to another feature, said estimation includes estimating the traffic types present based on traffic information contained in signaling messages received by a network element from at least one other network element.

According to another feature, said estimation includes estimating relative proportions for different traffic types obtained by measuring or counting traffic.

According to another feature, a traffic model representative of the traffic present is re-estimated each time a new connection is set-up and each time a connection is cleared down.

According to another feature, a traffic model representative of the traffic present is re-estimated at the end of a pre-determined time period.

According to another feature, the method includes a fourth step during which the reference traffic model is chosen that best approximates the traffic model estimated during the third step.

According to another feature, the method includes a fourth step during which the reference traffic model is chosen that best approximates the traffic model estimated during the third step and has the severest constraints.

According to another feature, the method includes a fifth step during which said at least one parameter of said algorithm is dynamically modified as a function of parameter(s) corresponding to the reference traffic model chosen during the fourth step.

According to another feature, a modification is effected only in the event of a significant change in said at least one parameter.

According to another feature, the method includes a sixth step during which said algorithm is executed with said at least one parameter modified during the fifth step.

According to another feature, the method is used for AAL2 connection admission control on an ATM virtual circuit.

According to another feature, the method is used for AAL2 connection admission control on an ATM virtual circuit at a Iub interface in a UTRAN.

According to another feature, the method is used for AAL2 connection admission control on an ATM virtual circuit at a Iu-CS interface in a UTRAN.

According to another feature, the method is used for AAL2 connection admission control on an ATM virtual circuit at a Iur interface in a UTRAN.

According to another feature, the method is used for admission control in a packet-switched mode network.

According to another feature, the method is used for admission control at the radio interface of a CDMA system.

The present invention also provides a radio access network element for use in a mobile radio system and including means for implementing the above method.

The present invention also provides a base station controller (RNC) for use in a mobile radio system and including means for implementing the above method.

The present invention also provides a base station (Node B) for use in a mobile radio system and including means for implementing the above method.

The present invention also provides a core network element for use in a mobile radio system and including means for implementing the above method.

Other objects and features of the present invention become apparent on reading the following description of an embodiment of the invention, which is given with reference to the accompanying drawings, in which:

FIG. 1 outlines the general architecture of a mobile radio system, and

FIG. 2 is a table setting out examples of margin values obtained for different traffic models.

The invention is explained below, by way of example, for the situation in which the CAC algorithm is applied to transport within the UTRAN. However, as previously indicated, the invention is not limited to this application.

The invention proposes to optimize the CAC algorithm so that at least one parameter of the algorithm is adapted dynamically as a function of a traffic model representative of the traffic present. This kind of dynamic adaptation can in part optimize the use of transmission resources.

The traffic present corresponds to the traffic taken into account by the CAC algorithm when it decides if a new connection request can be accepted. In this example, the traffic present corresponds to the traffic that can be multiplexed within an ATM virtual circuit.

A traffic model can in particular include one or more parameters representative of the type(s) of traffic present.

The “traffic type” concept is used here in the sense that a traffic type can be represented by any parameter or combination of parameters that can characterize the behavior of the traffic for the CAC algorithm. For example, these parameters can be taken from the following list, which is not exhaustive: activity factor, maximum bit rate, average bit rate, minimum bit rate, maximum time-delay, probability that the time-delay will be greater than the maximum time-delay, error rate, etc. In particular, in the application of the invention to transport within the UTRAN, a type of traffic can be represented by the following pair of parameters representative of quality of service requirements: the maximum transmission time-delay and the probability that the transmission time-delay will be greater than the maximum transmission time-delay.

If different traffic types are present, a traffic model can also include relative proportions for the various traffic types.

In other words, the invention proposes in particular to select dynamically the value of at least one parameter of the CAC algorithm so that said value corresponds to a value that is optimized for each traffic model. Values optimized for each traffic model can be determined by simulation or measurement, although other solutions are possible of course, for example calculation.

Failing the availability of values of said at least one parameter of the CAC algorithm optimized for each traffic model (in particular in the case of a large number of combinations of traffic types and relative proportions), some values, referred to as reference values, optimized for some models, referred to as reference models, can be used. A table can be provided in which these reference values and the corresponding reference models are stored.

This kind of method also enables dynamic selection of a value of said at least one parameter of the CAC algorithm by looking up in the table a value corresponding to a traffic model. For a traffic model that does not correspond to one of the reference models, a reference model can be determined that constitutes the best approximation of it. It is possible to determine the reference model that constitutes the best approximation and also has the severest constraints, i.e. the model that leads to accepting the least connections or the lowest load.

A method in accordance with the invention for dynamically adapting one or more parameters of the CAC algorithm as a function of the traffic model can include the following steps, for example:

1. Reference traffic models are determined in advance, for which reference values of the parameter(s) of the CAC algorithm to be adapted are determined (for example by calculation, simulation, or measurement).

2. Said reference traffic models and the associated reference values are stored in a memory.

3. A traffic model representative of the traffic present is estimated.

4. The reference traffic model is chosen that best approximates the traffic model estimated in step 3; the reference traffic model chosen can be the one that imposes the severest constraints on the CAC algorithm.

5. The parameter(s) of the CAC algorithm is or are modified as a function of the value of the parameter(s) of the CAC algorithm that corresponds to the reference traffic model chosen in step 4.

6. The CAC algorithm is executed using the parameter(s) modified in step 5.

The traffic model can be re-evaluated when each new connection is set-up and when each connection is cleared down. The mechanism can also loop regularly from step 6 to step 3, for example, to re-evaluate regularly the traffic model representative of the traffic really present, at the end of a certain time period, in order to adapt the evolution of the dynamic modification of the parameter(s) of the CAC algorithm to the evolution of the change of traffic model present, as a function of time. Said time period can be a configurable parameter, which can be made sufficiently low to obtain the best performance from the CAC algorithm and sufficiently high not to increase excessively the amount of processing. For example, the traffic model can be re-evaluated as a function of the time of day, the day of the week, etc.

Other variants can be envisaged, for example the option to repeat step 2, for example adding other reference traffic models or modifying the reference models already stored. For example, such modification can be based on traffic observations, such as observations carried out during step 3 to estimate a traffic model.

It may also be desirable to avoid excessively frequent modification of the CAC algorithm parameter(s), to which end variation thresholds (which can be configurable) can be introduced for each of the parameters in order to modify them only if a significant change of the parameters is necessary, or to prohibit excessively fast changes in these parameters, for example by setting a minimum time period (which can be configurable) between two successive changes of CAC algorithm parameters.

A method of invention can be implemented in any network element, for example the network element in which the CAC algorithm is executed. In the example of application of the invention to transport within the UTRAN, a method in accordance with the invention can be implemented in this way in a radio access network element such as an RNC or a Node B, or in a core network element, or in any network element interested in verifying that it has the necessary resources at the transport level before accepting a connection set-up request.

For example, a network element implementing a method of invention can include a memory for storing the reference values and models and means for executing the steps of the method of estimating the traffic model for the traffic present, choosing a reference traffic model, dynamically modifying the CAC algorithm parameter(s), and implementing the CAC algorithm with the modified parameter(s) if the network element concerned is that executing the CAC algorithm.

A network element executing the CAC algorithm generally does not know the traffic model representative of the traffic present. To evaluate a traffic model representative of the traffic present at the terrestrial interface at which it must execute the algorithm, it can use any means, such as traffic meters, for example, or it can use information on traffic contained in signaling messages received from at least one other network element. More generally, to estimate a traffic model representative of the traffic present, a network element can use any means of estimating the traffic types present and the relative proportions of the different traffic types if different traffic types are present.

For example, the network element that executes the CAC algorithm can be the CRNC (controlling RNC) at the Iub interface (or the Node B), the SRNC (serving RNC) and a core network element at the Iu interface, or the SRNC at the Iur interface.

The radio network controller that is controlling a given Node B is known as a controlling RNC (CRNC). The CRNC has a load control and radio resource allocation function for each Node B that it controls. There is also a serving RNC (SRNC) having a control function for a given call relating to a given user equipment UE. A Node B that is connected to the UE but is not controlled by the SRNC communicates with the SRNC via the RNC that controls it, which is known as a drift RNC (DRNC).

The means for estimating the traffic model can differ according to whether the network element that executes the CAC algorithm is the SRNC or the CRNC.

If the network element that executes the CAC algorithm is the SRNC, for example, it can use traffic information contained in signaling messages that it receives from the core network at the Iu interface conforming to the Radio Access Network Application Part (RANAP) communications protocol or the Iu Frame Protocol, for example.

The SRNC can also use traffic information contained in signaling messages that it receives from the Node B at the Iub interface conforming to the Node B Application Part (NBAP) communications protocol or the Iub Frame Protocol.

The SRNC can also use any means providing information on the traffic at the radio, Iub or Iu interface, such as meters.

If the network element that executes the CAC algorithm is the CRNC, for example, it can use traffic information contained in signaling messages that it receives from the SRNC at the Iur interface conforming to the Radio Network System Application Part (RNSAP) communications protocol or the Iur Frame Protocol, for example.

The CRNC can also use traffic information contained in signaling messages that it receives from the Node B at the Iub interface conforming to the NBAP or the Iub Frame Protocol.

The CRNC can also use any means providing information on the traffic at the radio, Iur or Iub interface, such as meters.

The RANAP is defined in 3G Technical Specification TS 25.413, the NBAP in 3G Technical Specification TS 25.433, the RNSAP in 3G Technical Specification TS 25.433, the Iu Frame Protocol in 3G Technical Specification TS 25.415, and the Iub/Iur Frame Protocol in 3G TS Technical Specification 25.427, all of which Technical Specifications are published by the 3^{rd} Generation Partnership Project (3GPP).

Messages received conforming to the RANAP can be radio access bearer (RAB) assignment request messages providing, for each RAB assignment request, information on the corresponding type of traffic or service in the form of parameters known as RAB parameters (including the maximum bit rate, the traffic class, and the transmission time-delay, or a source statistics descriptor (SSD) parameter).

Moreover, to determine parameters suitable for characterizing a traffic type in this kind of application, such as the maximum transmission time-delay and the probability that the transmission time-delay will be greater than the maximum transmission time-delay, it is also possible to use information configured by Operation & Maintenance (O&M) functions in a network element.

Moreover, in the UMTS, the maximum transmission time-delay parameter can be chosen as a function of the Time Of Arrival Window Start (TOAWS) parameter defined in the 3GPP UMTS standard, which represents the width of the downlink receive window in the Node B and is used for synchronization (see 3GPP TS 25.402).

Moreover, the parameter consisting of the probability that the time-delay will be greater than the maximum time-delay can be chosen as a function of the target AAL2 packet loss rate or ATM cell loss rate at the Iub interface for the transport of user data.

In particular, said at least one parameter of the CAC algorithm can correspond to the margin K_{VC}. This parameter is the one more particularly referred to in the present application, but other parameters could be used, of course. For example, the equivalent bandwidth could be varied, for example as a function of the activity factor of the connections.

For example, the equivalent bandwidth of the connections, for example voice connections for an AMR type service, could be adapted dynamically for a given maximum time-delay and a given probability that the time-delay will be greater than the maximum time-delay, as a function of the voice activity factor, or more generally as a function of parameter(s) representative of transmission resource requirements for a given quality of service (QoS). For example, a table can be provided for storing reference values of the equivalent bandwidth. The network element executing this kind of process can, for example, dynamically measure the average activity factor of voice connections, for example by evaluating the proportion of empty frames relative to frames containing voice, and thus dynamically adapt the equivalent bandwidth used for voice as a function of an average activity factor observed for all voice connections.

It will also be noted that the equivalent bandwidth can be equal to zero (or to a very low value), for example in the case of a packet-switched service that has few time-delay constraints.

The following description relates more particularly and by way of example to the situation in which said at least one CAC algorithm parameter is the margin K_{VC}.

FIG. 2 sets out examples, obtained by simulation, of the maximum acceptable load for the virtual circuit for different traffic models. A traffic model includes in this instance the following parameters representative of the type(s) of traffic present: maximum transmission time-delay, probability that the transmission time-delay will be greater than the maximum transmission time-delay and, if different traffic types are present, relative proportions for the different traffic types. To be more precise, the traffic models shown in FIG. 2 are as follows:

for multiplexed traffic of the same type:

[symbol] 100% speech (7 ms, 10⁻⁴)

[symbol] 100% PS144 (50 ms, 10⁻⁴)

[symbol] 100% CS64 (33 ms, 10⁻⁴)

for multiplexed traffic of different types:

[symbol] 75% speech (7 ms, 10⁻⁴)+25% PS144 (50 ms, 10⁻⁴)

[symbol] 50% speech (7 ms, 10⁻⁴)+50% PS144 (50 ms, 10⁻⁴)

[symbol] 25% speech (7 ms, 10⁻⁴)+75% PS144 (50 ms, 10⁻⁴)

[symbol] 75% CS64 (33 ms, 10⁻⁴)+25% PS144 (50 ms, 10⁻⁴)

[symbol] 50% CS64 (33 ms, 10⁻⁴)+50% PS144 (50 ms, 10⁻⁴)

[symbol] 25% CS64 (33 ms, 10⁻⁴)+75% PS144 (50 ms, 10⁻⁴)

The traffic models and the corresponding values of K_{VC} can constitute the reference values and models used the method as previously explained, for example.

FIG. 2 can also be used to compare the invention and the prior art.

In the prior art as summarized above, a value for K_{VC} is chosen that must be valid for all traffic models. A reasonable solution is to choose the traffic model with the severest constraints, which in the FIG. 2 example is that corresponding to 75% speech+25% PS144, leading to a choice of the value 0.74 for K_{VC}. This choice then rules out loading the virtual circuit to more than 74%. A problem then arises in that, for a different traffic model, for example the model corresponding to 25% CS64+75% PS144, it would in fact have been possible to load the virtual circuit to 80%, showing that the use of transmission resources is not optimized for all possible situations.

The present invention avoids these problems by selecting the value of K_{VC} dynamically, according to the traffic model. This dynamic choice of the value of K_{VC} increases transmission capacity as a function of the traffic model (from 0% to 22% in the FIG. 2 example). In other words, one advantage of selecting the value of K_{VC} dynamically is that the CAC algorithm is able to accept more connections than could have been accepted with a fixed value of K_{VC}, whilst at the same time guaranteeing that the quality of service constraints are complied with. Thus the performance of the CAC algorithm is enhanced.

What is claimed is:

1. A method of implementing an admission control algorithm in a telecommunications system, in which method at least one parameter of said algorithm is adapted dynamically as a function of a traffic model representative of the traffic present.

2. A method according to claim 1, wherein said traffic model includes one or more parameters representative of the type(s) of traffic present.

3. A method according to claim 2, wherein parameters representative of a type of traffic include parameters representative of quality of service (QoS) requirements for that traffic type.

4. A method according to claim 3, wherein parameters representative of quality of service requirements include a maximum transmission time-delay and a probability that the transmission time-delay will be greater than that maximum transmission time-delay.

5. A method according to claim 2, wherein parameters representative of the type of traffic include parameters representative of transmission resource requirements for said traffic type and for a given quality of service (QoS).

6. A method according to claim 5, wherein parameters representative of transmission resource requirements for a given quality of service (QoS) include a connection activity factor.

7. A method according to any one of claims 1 to 6, wherein, if different traffic types are present, said traffic model includes relative proportions for said different traffic types.

8. A method according to any one of claims 1 to 7, wherein said at least one parameter corresponds to a margin corresponding to a maximum acceptable load.

9. A method according to any one of claims 1 to 7, wherein said at least one parameter corresponds to an equivalent bandwidth.

10. A method according to any one of claims 1 to 9, wherein the value of said at least one parameter is chosen from different reference values optimized for different reference traffic models.

11. A method according to claim 10, wherein, for a traffic model that does not correspond to a reference traffic model, a reference traffic model is determined that constitutes the best approximation thereof.

12. A method according to claim 10, wherein, for a traffic model that does not correspond to a reference traffic model, a reference traffic model is determined that constitutes the best approximation thereof and has the severest constraints.

13. A method according to any one of claims 1 to 12, including a first step during which reference traffic models are determined and corresponding reference values for said at least one parameter are determined.

14. A method according to claim 13, wherein said reference values are determined by simulation or measurement.

15. A method according to claim 13, wherein said reference values are determined by calculation.

16. A method according to any one of claims 13 to 15, including a second step during which reference traffic models and corresponding reference values are stored in a memory.

17. A method according to any one of claims 13 to 16, including a third step during which a traffic model representative of the traffic present is estimated.

18. A method according to claim 17, wherein said estimation includes an estimation of the traffic types present and, if different traffic types are present, relative proportions for said different traffic types.

19. A method according to claim 18, wherein said estimation includes estimating the traffic types present based on traffic information contained in signaling messages received by a network element from at least one other network element.

20. A method according to claim 18, wherein said estimation includes estimating relative proportions for different traffic types obtained by measuring or counting traffic.

21. A method according to any one of claims 17 to 20, wherein a traffic model representative of the traffic present is re-estimated each time a new connection is set-up and each time a connection is cleared down.

22. A method according to any one of claims 17 to 20, wherein a traffic model representative of the traffic present is re-estimated at the end of a pre-determined time period.

23. A method according to any one of claims 13 to 22, including a fourth step during which the reference traffic model is chosen that best approximates the traffic model estimated during the third step.

24. A method according to any one of claims 13 to 23, including a fourth step during which the reference traffic model is chosen that best approximates the traffic model estimated during the third step and has the severest constraints.

25. A method according to any one of claims 13 to 24, including a fifth step during which said at least one parameter of said algorithm is dynamically modified as a function of parameter(s) corresponding to the reference traffic model chosen during the fourth step.

26. A method according to claim 25, wherein a modification is effected only in the event of a significant change in said at least one parameter.

27. A method according to any one of claims 13 to 26, including a sixth step during which said algorithm is executed with said at least one parameter modified during the fifth step.

28. A method according to one any one of claims 1 to 27, used for AAL2 connection admission control on an ATM virtual circuit.

29. A method according to claim 28, used for AAL2 connection admission control on an ATM virtual circuit at a Iub interface in a UTRAN.

30. A method according to claim 28, used for AAL2 connection admission control on an ATM virtual circuit at a Iu-CS interface in a UTRAN.

31. A method according to claim 28, used for AAL2 connection admission control on an ATM virtual circuit at a Iur interface in a UTRAN.

32. A method according to any one of claims 1 to 27, used for admission control in a packet-switched mode network.

33. A method according to any one of claims 1 to 27, used for admission control at the radio interface of a CDMA system.

34. A radio access network element for use in a mobile radio system and including means for implementing a method according to any one of claims 1 to 33.

35. A base station controller (RNC) for use in a mobile radio system and including means for implementing a method according to any one of claims 1 to 33.

36. A base station (Node B) for use in a mobile radio system and including means for implementing a method according to any one of claims 1 to 33.

37. A core network element for use in a mobile radio system and including means for implementing a method according to any one of claims 1 to 33.
